(19) United States
(12) Patent Application Publication
(10) Pub. No.: US 2013/0257760 A1
(43) Pub. Date: Oct. 3, 2013

(54) ELECTRONIC DEVICE COMPRISING TOUCH SCREEN AND INPUT METHOD OF ELECTRONIC DEVICE

(71) Applicant: CHI MEI COMMUNICATION SYSTEMS, INC., New Taipei (TW)

(72) Inventors: SHIH-HAO CHEN, New Taipei (TW); YI-HSUEH LEE, New Taipei (TW)

(73) Assignee: CHI MEI COMMUNICATION SYSTEMS, INC., New Taipei (TW)

(21) Appl. No.: 13/751,022

(22) Filed: Jan. 25, 2013

(30) Foreign Application Priority Data
Apr. 2, 2012 (TW) 101111750

(51) Int. Cl. G06F 3/0488

(52) U.S. Cl. CPC G06F 3/0488
USPC 345/173

(57) ABSTRACT

An electronic device including a touch screen includes a first determination module, a first display module, and a locating module. The first display module combines an input method interface with original content of the touch screen and displays a combination of the input method interface with the original content. The locating module detects a location touched by a user on the touch screen to determine a pressed key of the input method interface, and produces input data according to the pressed key.

### BACKGROUND

1. Technical Field

Present disclosure is related to an electronic device and a touch screen input method, and especially related to an electronic device including a touch screen and a touch screen input method of the electronic device.

2. Description of Related Art

A cell phone is an example of an electronic device including a touch screen which can use a touch screen input method. An input method interface of the cell phone occupies a large portion of the touch screen of the cell phone, and prevents users from clearly seeing original content of the touch screen of the cell phone.

Therefore, there is room for improvement within the prior art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a schematic diagram of one embodiment of an electronic device comprising a touch screen.

FIG. 2 is a functional modules diagram of an input system of FIG. 1.

FIG. 3 is a flowchart of one embodiment of an electronic device comprising a touch screen.

FIG. 4 is a schematic diagram of an input method interface.

FIG. 5 is a schematic diagram for determining a pressed key according to a location pressed by a user.

### DETAILED DESCRIPTION

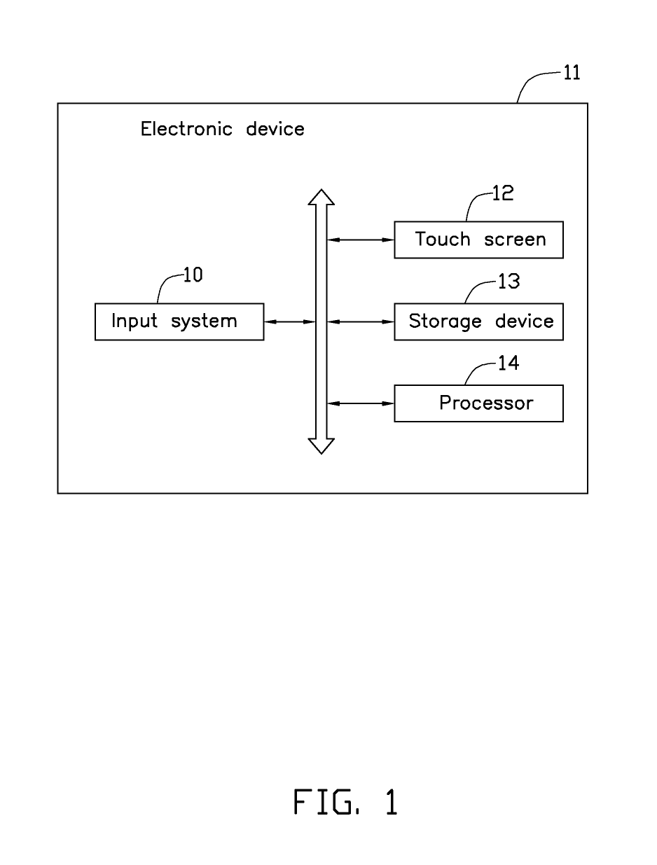

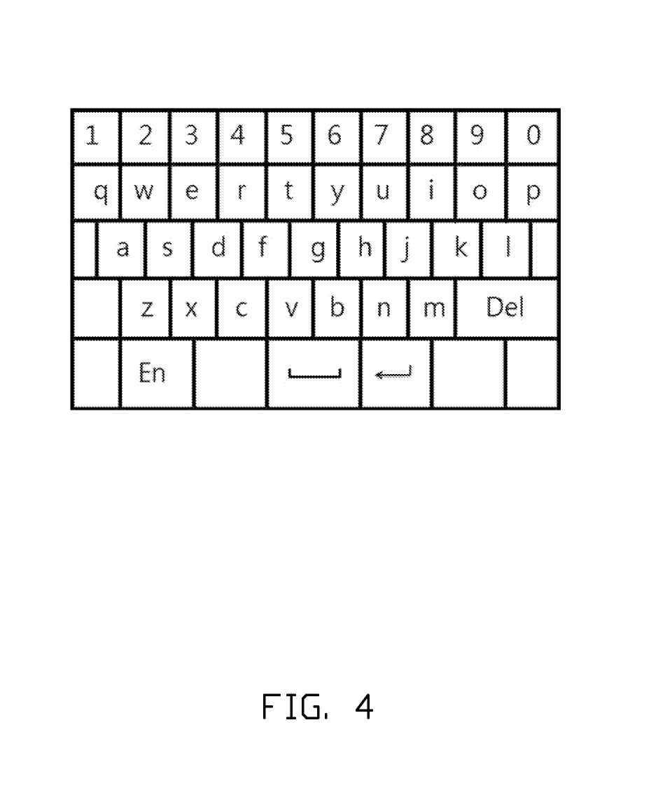

FIG. 1 is a schematic diagram of one embodiment of an electronic device 11 comprising a touch screen 12 and an input system 10. The electronic device 11 further includes a storage device 13 and at least one processor 14. The touch screen 12 transmits a signal when a user touches the touch screen 12 using one or more fingers, or a stylus. The touch screen 12 may be a resistive touch screen, a capacitive touch screen, or a touch screen of another type. Computerized codes for displaying an input method interface (shown in FIG. 4) are saved into the storage device 13. A size of the input method interface is about equal to a size of the touch screen 12. Referring to FIG. 4, the input method interface includes a plurality of keys, including number keys, letter keys, and symbol keys, for example. The storage device 13 saves program codes of the input system 10 and data generated in an operating process of the electronic device 11. The processor 14 executes the program codes of the input system 10 to combine the input method interface with original content of the touch screen 12. A combination of the input method interface with the original content is displayed on the touch screen 12.

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

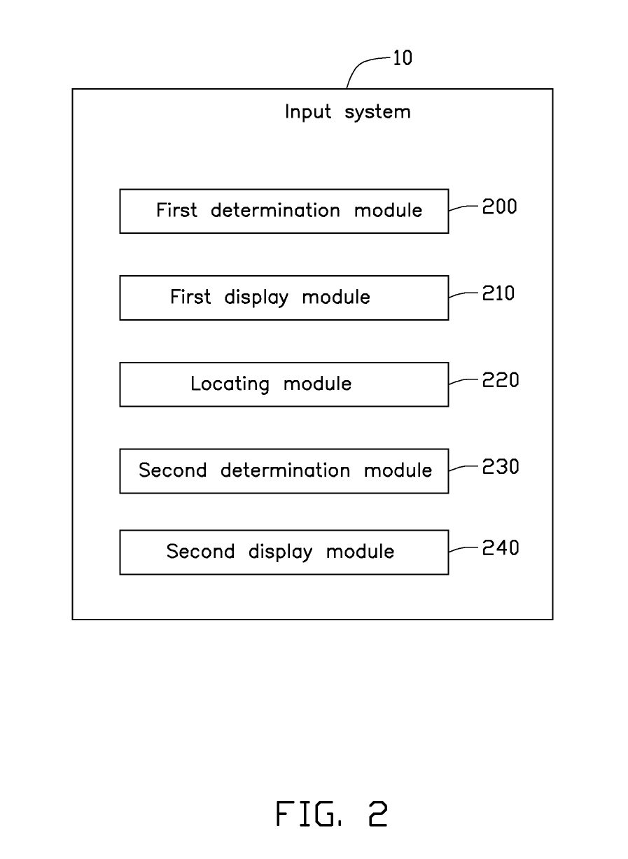

FIG. 2 is a functional modules diagram of the input system 10 of FIG. 1. In the embodiment, the input system 10 includes a first determination module 200, a first display module 210, a locating module 220, a second determination module 230, and a second display module.

The first determination module 200 determines whether the input method interface needs to be used.

The first display module 210 displays the input method interface on the touch screen 12 when the input method interface needs to be used. The first display module 210 combines the input method interface with the original content of the touch screen 12. A combination of the input method interface with the original content is displayed on the touch screen 12. In one embodiment, the first display module 210 adopts a mixed algorithm, AlphaBlend algorithm, for example, to combine the input method interface with the original content of the touch screen 12. The input method interface and the original content of the touch screen 12 are superimposed and overlaid together. The following is a formula of the mixed algorithm.

R (result of combination)=(1−alpha)*R(original content of the touch screen)+alpha*R(input method interface).

G (result of combination)=(1−alpha)*G(original content of the touch screen)+alpha*G(input method interface).

B (result of combination)=(1−alpha)*B(original content of the touch screen)+alpha*B(input method interface).

An alpha factor is transparency of the input method interface, and the alpha factor is a value between zero and one. The user may adjust the value of the alpha factor to acquire a preferred result of the combination of the input method interface with the original content. R, G, and B are expressed components of three primary colors, red, green, and blue, of pixels of the touch screen 12.

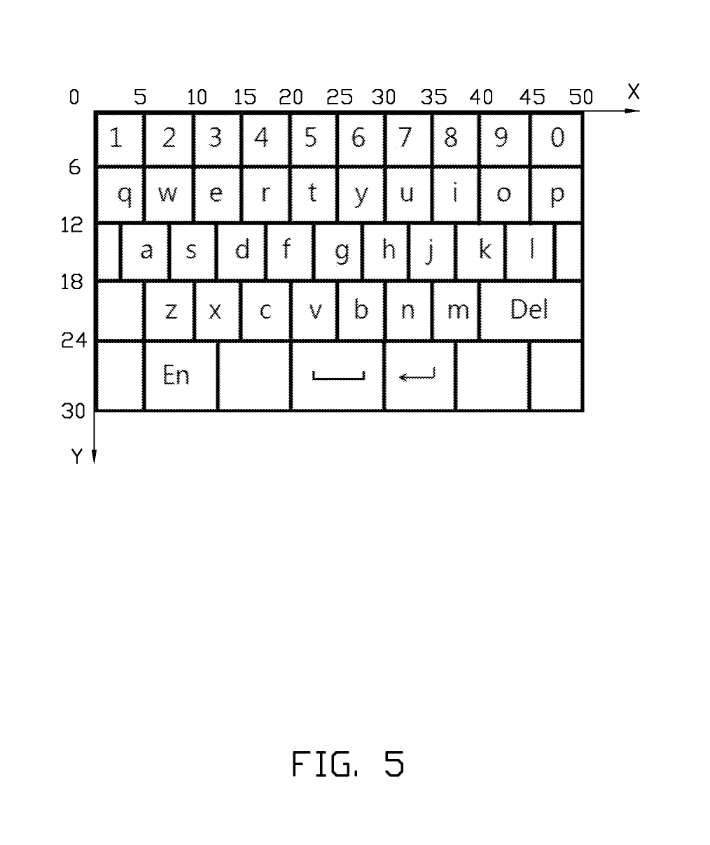

The locating module 220 detects a location touched by the user on the touch screen 12 to determine a pressed key of the input method interface according to the location. The locating module 220 produces input data including input coordinates of the pressed key. FIG. 5 is a schematic diagram for determining the pressed key according to the location pressed by the user. In FIG. 5, if the location is in a limited zone of (0, 0) and (5, 6), then the numeric key “1” is determined for the pressed key. In the embodiment, the locating module 220 acquires coordinates of the location according to a touch circuit of the touch screen 12, and determines the pressed key by contrasting the coordinates of the location touched by the user with the coordinates of the locations of all the keys. In the embodiment, the locating module 220 generates a parameter according to the pressed key and transmits the parameter to an operation system of the electronic device 11. Different parameters are transmitted according to different keys. For example, if the coordinates of the location touched by the user are denoted as (1, 2), the number key “1” has been pressed. The locating module 220 transmits a confirmation, such as a key_input event, to the operation system of the electronic device 11 and the parameter of the key_input event is two. Each parameter corresponding to each key is preset.

The second determination module 230 determines whether a back_key of the input method interface is pressed.

The second display module 240 displays the original content of the touch screen 12 without any transparency when the back_key is pressed.

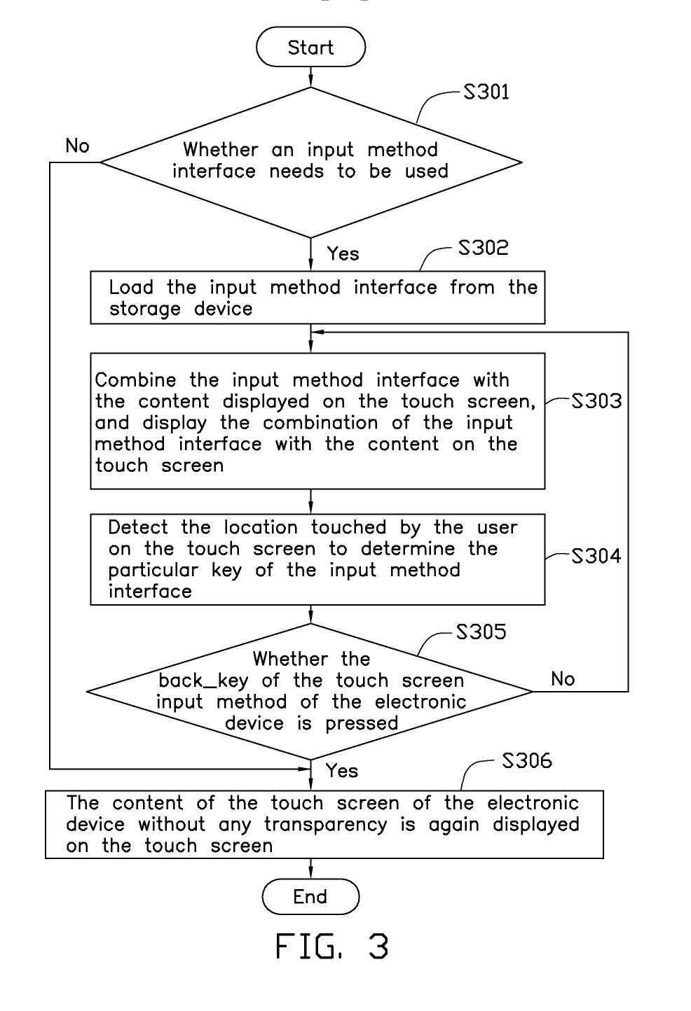

FIG. 3 is a flowchart of one embodiment of the electronic device 11 including the touch screen 12.

In step S301, the first determination module 200 determines whether an input method interface needs to be used. If the input method interface does not need to be used, then step S306 is implemented.

If the input method interface needs to be used, then step S302 is implemented. In step S302, the first display module 210 displays the input method interface on the touch screen 12, and then step S303 is implemented.

In step S303, the first display module 210 combines the input method interface with original content of the touch screen 12, and displays a combination of the input method interface with the original content. In the embodiment, the first display module 210 adopts the mixed algorithm, AlphaBlend algorithm, for example, to combine the input method interface with the original content of the touch screen 12. The input method interface and the original content are superimposed and overlaid together.

When a user inputs on the touch screen 12 according to the input method interface, step S304 is implemented. In step S304, the locating module 220 detects a location touched by the user to determine a pressed key of the input method interface. The locating module 220 produces input data according to the pressed key. FIG. 5 is a schematic diagram for determining the pressed key according to the location pressed by the user. In FIG. 5, if the location is in a limited zone of (0, 0) and (5, 6), then the numeric key “1” is determined for the pressed key. In the embodiment, the locating module 220 acquires coordinates of the location according to a touch circuit of the touch screen 12, and determines the pressed key by contrasting the coordinates of the location touched by the user with the coordinates of the locations of all the keys. In the embodiment, the locating module 220 generates a parameter according to the pressed key and transmits the parameter to an operation system of the electronic device 11.

Different parameters are transmitted according to different keys. For example, if the coordinates of the location touched by the user are denoted as (1, 2), the number key “1” has been pressed. The locating module 220 transmits a confirmation, such as a key_input event, to the operation system of the electronic device 11 and the parameter of the key_input event is two, and then step S305 is implemented. Each parameter corresponding to each key is preset.

In step S305, the second determination module 230 determines whether a back_key of the input method interface of the electronic device 11 is pressed. If the back_key is not pressed, then step S303 is implemented.

If the back_key is pressed, then step S306 is implemented. In step S306, original content of the touch screen 12 of the electronic device 11 without any transparency is displayed on the touch screen 12.

Depending on the embodiment, certain of the steps described may be removed, others may be added, and the sequence of the steps may be altered. It is also to be understood that the description and the claims drawn to a method may include some indication in reference to certain steps. However, the indication used is only to be viewed for identifier purposes and not necessarily as a suggestion as to an order for the steps.

The present disclosure is submitted in conformity with patent law. The above disclosure is the preferred embodiment. Any one of ordinary skill in this field can modify and change the embodiment within the spirit of the present disclosure, and all such changes or modifications are deemed included in the scope of the following claims.

What is claimed is:

1. An electronic device, comprising:
a touch screen;
a storage device;
at least one processor; and
one or more modules stored in the storage device and executed by the at least one processor, the one or more modules comprising:
a first determination module determining whether an input method interface needs to be used;
a first display module displaying the input method interface on the touch screen when the input method interface needs to be used; and
a locating module detecting a location touched by a user on the touch screen, determining a pressed key of the input method interface according to the location, and producing input data according to the pressed key.

2. The electronic device of claim 1, wherein the one or more modules further comprise:
a second determination module determining whether a back_key of the input method interface is pressed.

3. The electronic device of claim 1, wherein the one or more modules further comprise:
a second display module displaying original content of the touch screen when the back_key is pressed.

4. The electronic device of claim 1, wherein a size of the input method interface is about equal to a size of the touch screen, and the original content of the touch screen is overlaid by the input method interface.

5. The electronic device of claim 1, wherein the first display module adopts a mixed algorithm to combine the input method interface with the original content of the touch screen.

6. The electronic device of claim 1, wherein the locating module detects the location touched by the user according to a touch circuit of the touch screen and determines the pressed key according to the location.

7. A touch screen input method of an electronic device comprising a touch screen, the touch screen input method comprising:
determining whether an input method interface of the electronic device needs to be used;
displaying the input method interface on the touch screen when the input method interface needs to be used;
displaying a combination of the input method interface with original content of the touch screen; and
determining a pressed key of the input method interface by detecting a location touched by a user on the touch screen, and producing input data according to the pressed key.

8. The touch screen input method of claim 7, further comprising:
determining whether a back_key of the input method interface is pressed.

9. The touch screen input method of claim 7, further comprising:
displaying the original content of the touch screen when the back_key is pressed.

10. The touch screen input method of claim 7, further comprising:
adopting a mixed algorithm to combine the input method interface with the original content.

11. The touch screen input method of claim 7, further comprising:
obtaining the location touched by the user according to a touch circuit of the touch screen and determining the pressed key according to the location.

12. The touch screen input method of claim 7, wherein a size of the input method interface is about equal to a size of the touch screen, and the original content is overlaid by the input method interface.

13. A non-transitory computer-readable storage medium having stored thereon instructions that, when executed by at least one processor of an electronic device, cause the processor to perform a touch screen input method of the electronic device, the electronic device comprising a touch screen, the touch screen input method comprising:
determining whether an input method interface needs to be used;
displaying the input method interface on the touch screen when the input method interface needs to be used;
displaying a combination of the input method interface with original content of the touch screen; and
determining a pressed key of the input method interface by detecting a location touched by a user on the touch screen, and producing input data according to the pressed key.

14. The storage medium of claim 13, wherein the method further comprises:
determining whether a back_key of the input method interface is pressed.

15. The storage medium of claim 13, wherein the method further comprises:
displaying the original content display of the touch screen when the back_key is pressed.

16. The storage medium of claim 13, wherein the method further comprises:
adopting a mixed algorithm to combine the input method interface with the original content.

17. The storage medium of claim 13, further comprising:
obtaining the location touched by the user according to a touch circuit of the touch screen and determining the pressed key according to the location.

18. The storage medium of claim 13, wherein a size of the input method interface is about equal to a size of the touch screen, and the original content is overlaid by the loaded input method interface.
